(19) United States
(12) Patent Application Publication
(10) Pub. No.: US 2003/0155009 A1
(43) Pub. Date: Aug. 21, 2003

(54) Drain apparatus with a branch tube and a valve for removing a blockage in the drain

(76) Inventor: Ponsub Tanomwongtai, Petchaboon (TH)

Correspondence Address: BIRCH STEWART KOLASCH & BIRCH, PO BOX 747, FALLS CHURCH, VA, 22040-0747, US

(21) Appl. No.: 10/367,940

(22) Filed: Feb. 19, 2003

(30) Foreign Application Priority Data
Feb. 19, 2002 (TH) 071847

(51) Int. Cl. F16K 3/36

(52) U.S. Cl. 137/240

(57) ABSTRACT

The present invention is an apparatus for removing a blockage inside the drain of any bathroom and kitchen sinks, bathroom floor, etc. regardless of the drain's position and size. Removal can be accomplished easily by opening the valve to let water or air in and the problem of blocked drains will be gone.

This method is convenient and can save money, time and labor. It is not necessary to disassemble the drain, use a shooting device nor buy a toxic substance to pour into the drain which is a practice that is difficult, fatally dangerous and harmful to the environment.

### CHARACTERISTICS AND OBJECTIVES OF THE INVENTION

A drain apparatus can be one of two shapes, i.e. cylindrical and convex-concave. It is a circular tube with a small tube branching from its side for connecting with high-pressure water or air in order to push a blockage out of the drain. A valve plate is mounted at the junction of the small tube to prevent backward flow and close the end of the small tube when it is in its normal position. And when pressure is fed into the small tube, the valve plate is pushed into the position that closes the upper opening of the drain by coupling with a valve seat that is above the small tube's opening.

The primary objective is to remove a blockage in the drain regardless of the drain's position.

Another objective is to increase convenience and save money, time and labor. There will be no need to disassemble the drain, to use a shooting device nor to buy a toxic substance to corrode the blockage in the drain and this last practice is fatally dangerous to human, animals and harmful to the environment.

### RELATED ART

The present invention is related to civil engineering.

### PRIOR ART

A regular drain is a circular tube. After it has been used for a long period of time, bits and pieces will gather inside the tube and block it and water will not be able to flow through it. This leads to problems in bathroom and kitchen sinks, bathrooms etc. In addition, there will be a stench which travels up the drain and fills the bathroom and house with an undesirable smell.

### BRIEF DESCRIPTION OF THE DRAWINGS

FIG. 1 shows a cylindrical drain apparatus according to the present invention. The valve can be seen in its normal position which leaves the opening open and closes the branch tube.

FIG. 2 shows the drain apparatus with its valve closing the upper opening by coupling with the valve seat.

FIG. 3 shows a convex-concave drain apparatus according to the invention with its valve in the normal position which opens the upper opening, closes the branch tube, and the convex part.

FIG. 4 shows the drain apparatus while the valve is in the position that closes the upper opening by coupling with the valve seat.

FIG. 5 shows connections of drains at several points with a convex-concave drain apparatus at every point. At the first point, the valve closes the upper opening by coupling with the valve seat.

FIG. 6 is a continuation of FIG. 5. It can be seen that the valves close the upper openings at both points.

### COMPLETE DISCLOSURE OF THE INVENTION

A drain apparatus with a branch tube and a valve for removing a blockage in the drain that can be connected to bathroom and kitchen sinks, bathroom floor, etc. has been invented.

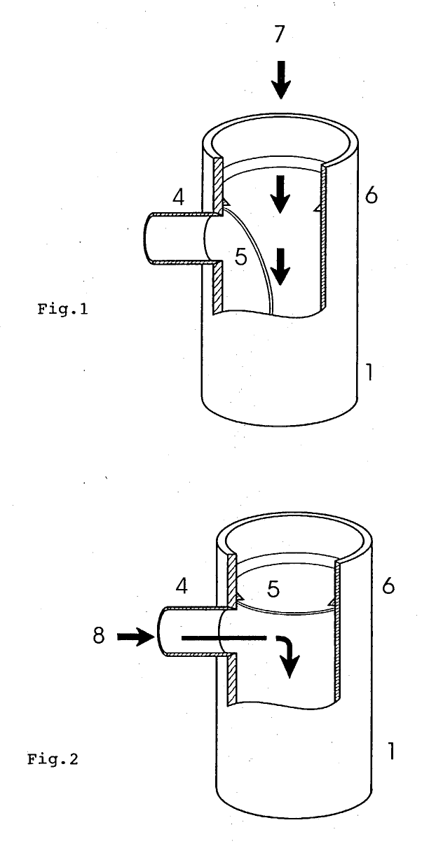

FIG. 1 is a cylindrical drain apparatus according to the invention. It is a straight, circular tube 1 with a small tube 4 branching from its side for connecting with high-pressure water or air 8. Inside the circular tube 1, a valve 5 is mounted. In its normal position, the valve 5 will close the end of the small tube 4, opens its upper opening so that sewage 7 can flow downward. Also, there is a valve seat 6 over the end of the small tube 4 for coupling with the valve 5 when water and air 8 push the valve 5 to move up to close the opening.

FIG. 2 is a continuation from FIG. 1. While high-pressure water or air 8 is injected into the small tube 4, the water or air 8 will push the valve 5 to close the upper opening by coupling with the valve seat 6. The water and air 8 will flow downward in order to push the blockage out of the drain.

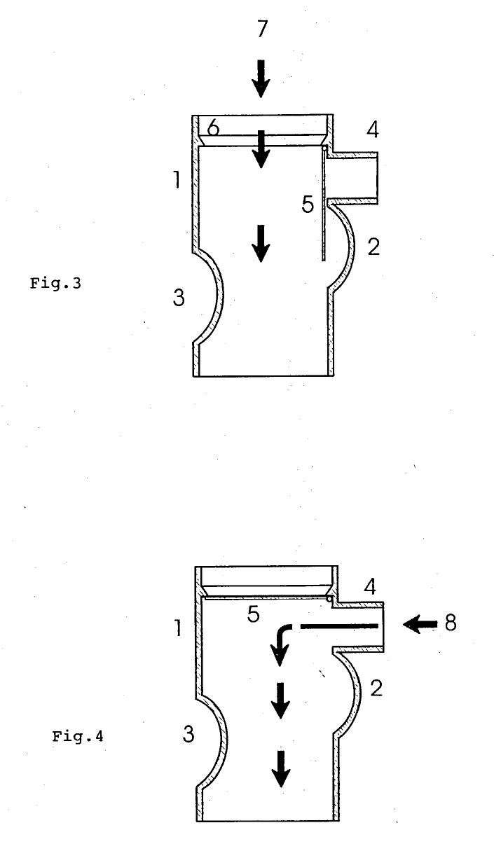

FIG. 3 is a convex-concave drain apparatus according to the invention. It is a circular tube 1 with a small tube 4 branching from its side for connecting with high-pressure water or air 8. A valve 5 is mounted inside the tube 1. In its normal position, the valve 5 closes the end of the small tube 4, leaving the tube's opening open so that sewage 7 can flow downward. In addition, there is a valve seat 6 over the end of the small tube 4 for coupling with the valve 5 when the water and air 8 push the valve 5 upward to close the opening. The convex part 2 is below the small tube 4 and the concave part 3 is lower.

FIG. 4 is a continuation from FIG. 3. When high-pressure water or air 8 is injected into the small tube 4, the water and air 8 will push the valve 5 upward into the position that closes the upper opening by coupling with the valve seat 6. The water and air 8 will flow downward to push the blockage out of the drain.

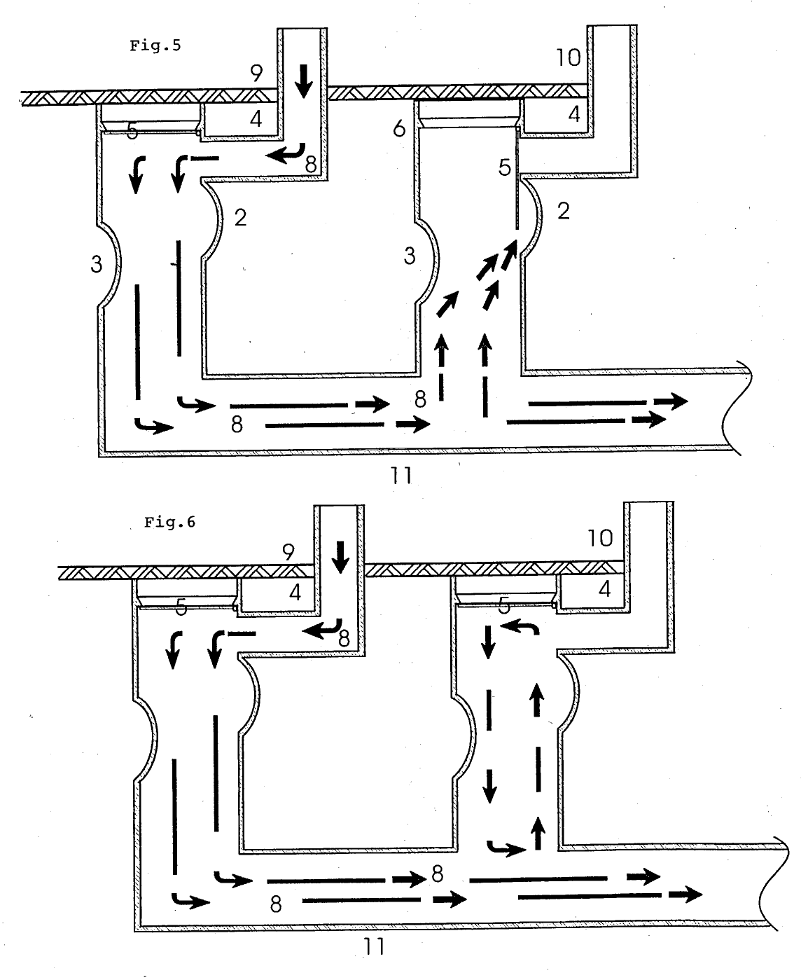

FIG. 5 shows connections of drains at several points with this convex-concave drain apparatus being mounted. Starting at point 9, when high-pressure water or air 8 is injected into the small tube 4, the water or air 8 will push the valve 5 into the position that closes the upper opening. The water or air 8 will flow to point 10. When the water or air 8 reaches point 10 of the drain apparatus, it will hit the concave part 3 and then flow into the convex part 2. Then, it will push the valve 5 at point 10 into the position that closes the upper opening.

FIG. 6 is a continuation from FIG. 5. When the valves 5 at points 9 and 10 close the upper openings, the water and air 8 will flow along tube II to push the blockage out.

### BEST METHOD FOR PRACTICING THE INVENTION

The best method is as stated above and valves should be made from light and floatable materials. These will lead to the invention that is perfect and best.

1. A drain apparatus with a branch tube and a valve for removing a blockage in the drain, in either cylindrical or curved forms.

2. A cylindrical drain apparatus which is a straight circular tube with a small tube branching from its side for connecting with high-pressure water or air, wherein
a valve is mounted inside the cylindrical drain apparatus and in its normal position, the valve closes the end of the branch tube, leaving the upper opening open so that water can flow down and
a valve seat is provided inside the cylindrical drain apparatus over the end of the branch tube for coupling with the valve when it is in the position that closes the opening.

3. A convex-concave drain apparatus which comprises a circular tube, a branch tube, a valve and a valve seat in shapes such as cylindrical, with a convex part below the branch tube and a concave part further below.
